(19) United States
(12) Patent Application Publication
(10) Pub. No.: US 2009/0036266 A1
(43) Pub. Date: Feb. 5, 2009

(54) Driving assist method for a vehicle including an automatic transmission, driving assist control program, and driving assist apparatus for a vehicle including an automatic transmission

(75) Inventors: Yoshito Kondou, Okazaki-shi (JP); Takayuki Miyajima, Anjo-shi (JP); Atsushi Takeuchi, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/219,870

(22) Filed: Jul. 30, 2008

(30) Foreign Application Priority Data
Aug. 1, 2007 (JP) 2007-200762

(51) Int. Cl. B60W 10/10; G06F 17/00

(52) U.S. Cl. 477/92; 701/53

(57) ABSTRACT

A driving assist method and driving assist apparatus enable appropriate deceleration in a downshift. If a downshift operation increases the torque output of the engine, and if it is determined that vehicle speed would otherwise be accelerated before the completion of the downshift, an electronic transmission control unit calculates a deceleration for offsetting the acceleration. On the basis of the calculated deceleration, the electronic transmission control unit controls a braking device via an electronic brake control unit to apply a braking force to the vehicle to thereby suppress the acceleration of the vehicle which would otherwise be produced by the increase in engine torque produced by the downshift.

### INCORPORATION BY REFERENCE

The disclosure of Japanese Patent Application No. 2007-200762 filed on Aug. 1, 2007, including the specification, drawings and abstract thereof, is incorporated herein by reference in its entirety.

### BACKGROUND OF THE INVENTION

1. Field of the Invention

The present invention relates to a driving assist method for a vehicle including an automatic transmission, a computer readable medium with a driving assist control program encoded thereon, and a driving assist apparatus for a vehicle which includes an automatic transmission.

2. Description of the Related Art

In recent years, transmissions have been provided with two different modes of operation, i.e. an automatic transmission mode in which the gearshift is automatically performed in accordance with a previously prepared (predetermined) gearshift map and a manual transmission mode in which the gearshift is performed through manual operation of a shift lever. Generally, the manual transmission mode is turned on by the operation of a shift lever. For example, in engine braking, the gearshift of the transmission is performed through a lever operation (a downshift) to increase engine braking force.

In the manual transmission mode, if a request for a downshift is received when there is a significant difference between the engine rotational speed and the output rotational speed (the output shaft rotational speed of the transmission), a sudden and large gearshift shock is generated.

Because the gear ratio of the automatic transmission is increased in a downshift, the rotational speed of the engine needs to be increased. However, the throttle valve is closed for engine braking. Therefore, the torque of the output shaft of the automatic transmission is transmitted to the engine due to torque transmission resulting from the connection made by engagement of a frictional engagement device of the automatic transmission.

As a result, inertial torque generated along with the increase in the engine rotational speed acts as a braking torque for braking the vehicle. In this case, as the time of engagement (connection time) of the frictional engagement device of the automatic transmission (the gearshift time) is reduced, the braking torque is rapidly increased to increase the gearshift shock.

In view of the above, Japanese Unexamined Patent Application Publication No. 10-103479 (hereinafter, “JP'479”), teaches that to enable a smooth gearshift without causing a sudden and large gearshift shock, the engine torque is rapidly increased to make the two rotational speeds match each other.

### SUMMARY OF THE INVENTION

In accordance with the teachings of JP'479, if the downshift is performed on a downhill slope through the operation of the shift lever with the accelerator pedal in an OFF state for engine braking, for example, a sensation of acceleration is created by the gearshift due to the rapid increase in the engine torque.

In the above case, responsive to the increase in the gear ratio of the automatic transmission by the downshift, an engine control unit controls the engine to increase the engine rotational speed and, due to the increase in the engine rotational speed, the engine output is increased.

In the process of JP'479, if there arises a difference between the timing of increase in the engine output and the timing of engagement of the frictional engagement device of the automatic transmission, the engine output is transmitted to the output shaft of the automatic transmission, and the speed of the vehicle is increased. On the other hand, if, contrary to the method taught by JP'479, the engine torque is not increased in the downshift, and the frictional engagement device of the automatic transmission is only loosely engaged to prevent a large gearshift shock, there occurs a time lag until a feeling of deceleration can be sensed and responsiveness to a requested operation cannot be obtained.

Accordingly, one object of the present invention is to solve the above-mentioned problems. In furtherance of that and other objects, the present invention provides a driving assist method for a vehicle including an automatic transmission, a computer-readable medium having a driving assist control program encoded thereon, and a driving assist apparatus for a vehicle including an automatic transmission, to enable appropriate deceleration in a downshift.

In a first aspect, the present invention provides a driving assist method, for a vehicle having an automatic transmission, for performing a gearshift to change a gear ratio of the transmission on the basis of a gearshift map and to increase the gear ratio of the transmission responsive to a downshift operation of a shift lever. The method includes: calculating, responsive to the downshift operation of the shift lever, a post-gearshift engine rotational speed to be established after the gearshift; comparing the calculated post-gearshift engine rotational speed with a pre-gearshift engine rotational speed, and determining whether or not to execute deceleration by a brake control unit on the basis of the result of the comparison; calculating a necessary deceleration upon determination of deceleration performance of the brake control unit; and controlling braking on the basis of the calculated necessary deceleration until completion of the gearshift.

The method of the present invention may further include a step of increasing the torque of the engine responsive to the downshift operation of the shift lever.

In another aspect, the present invention provides a computer-readable medium which has encoded thereon a driving assist control program which causes a computer to control changing a gear ratio of a transmission on the basis of a gearshift map and to control the transmission to perform a gearshift to increase its gear ratio responsive to a downshift operation of a shift lever. The program causes the computer to function as: a downshift determination unit for determining (detecting) a downshift operation of the shift lever; an estimated engine rotational speed calculation unit for calculating, on the basis of the downshift operation, a post-gearshift engine rotational speed which would otherwise be obtained after the downshift; an immediately preceding engine rotational speed detection unit for detecting pre-gearshift engine rotational speed; a deceleration determination unit for comparing the post-gearshift engine rotational speed with the pre-gearshift engine rotational speed, and determining whether or not to decelerate with the brake control unit based on the result of the comparison; a deceleration calculation unit for calculating a necessary deceleration value based on a determination by the deceleration determination unit of the deceleration performance of the brake control unit; and a brake control signal generation unit for generating, on the basis of the value for necessary deceleration calculated by the deceleration calculation unit, a control signal for control of braking of the vehicle, and for outputting the signal to the brake control unit until completion of the downshift.

In a preferred embodiment of the driving assist control program, the computer is also caused to function as a torque-up signal generation unit for generating a control signal for increasing the torque of the engine responsive to the downshift operation of the shift lever.

In yet another aspect, the present invention provides a driving assist apparatus for a vehicle including an automatic transmission, which apparatus executes a gearshift to change the gear ratio of the transmission on the basis of a gearshift map and to increase the gear ratio of the transmission in response to a downshift operation of a shift lever. The apparatus includes: a shift lever position detection unit for detecting position of the shift lever; a downshift determination unit for determining a downshift operation of the shift lever based on a detection signal from the shift lever position detection unit; an estimated engine rotational speed calculation unit for calculating, upon determination of a downshift operation, a post-gearshift engine rotational speed, as an estimated engine rotational speed; an immediately preceding engine rotational speed detection unit for detecting a pre-gearshift engine rotational speed, i.e. the immediately preceding engine rotational speed; a deceleration determination unit for comparing the estimated engine rotational speed with the immediately preceding engine rotational speed, and determining whether or not to decelerate by operation of the brake control unit on the basis of the result of the comparison; a deceleration calculation unit for calculating a necessary deceleration upon determination by the deceleration determination unit of the performance of the deceleration by the brake control unit; and a brake control signal generation unit for generating, on the basis of the necessary deceleration calculated by the deceleration calculation unit, a control signal for controlling braking of the vehicle, and outputting the signal to the brake control unit until the completion of the gearshift.

The driving assist apparatus of the present invention may further include a throttle opening determination unit for determining whether or not the engine throttle is closed. Upon determination by the throttle opening determination unit that the throttle is closed, the deceleration determination unit determines whether or not the brake unit is to decelerate.

The driving assist apparatus of the present invention may also include a torque-up signal generation unit for generating a control signal for increasing the torque of the engine upon determination by the downshift determination unit of the downshift operation.

According to the method of the present invention, responsive to a downshift operation of the shift lever, a determination is made as to whether or not to decelerate by application of the brake control unit, the determination being based on the comparison between the post-gearshift engine rotational speed and the pre-gearshift engine rotational speed. Further, the deceleration performance of the brake control unit is determined, the necessary deceleration is calculated, and the brake control is based on the calculated necessary deceleration. Accordingly, appropriate deceleration is achieved.

Thus, in the present invention, even if the torque of the engine is increased by the downshift, the acceleration of the vehicle is suppressed.

In the method of the present invention, upon a downshift operation of the shift lever, whether or not to decelerate by application of the brake control unit is determined on the basis of the result of a comparison between the post-gearshift engine rotational speed of the engine and the pre-gearshift engine rotational speed. Further, the performance in deceleration by the brake control unit is determined and the necessary deceleration is calculated. Then, on the basis of the calculated necessary deceleration, the braking of the vehicle is appropriately controlled by the brake control unit to decelerate the vehicle. Accordingly, appropriate deceleration is achieved.

Another feature of the invention is that, even if the engine output torque is increased by the downshift, the acceleration of the vehicle is-suppressed.

According to another preferred embodiment of the method of the present invention, responsive to the downshift operation of the shift lever, a determination is made as to whether or not to decelerate by braking, based on the result of the comparison between the post-gearshift engine rotational speed and the pre-gearshift engine rotational speed. Further, if the deceleration performance of the brake unit (device) is determined, the necessary deceleration can be calculated. Then, on the basis of the calculated necessary deceleration, the braking of the vehicle is appropriately controlled by the brake control unit to decelerate the vehicle.

According to another preferred embodiment of the present invention, responsive to movement of the shift lever, if the accelerator pedal has not been pressed down, the brake driving unit is controlled for deceleration. Accordingly, the brake control is consistent with the intention of the driver.

According to yet another aspect of the present invention, even if the torque of the engine is increased upon operation of the shift lever for a downshift, appropriate control of the deceleration is provided.

### BRIEF DESCRIPTION OF THE DRAWINGS

FIG. 1A is a schematic diagram of a drive train and brake system of a vehicle, according to an embodiment of the present invention; and FIG. 1B is a block diagram of the transmission control unit 22.

FIG. 2 is a block diagram of an embodiment of the driving assist apparatus of the present invention;

FIG. 3 is a diagram of a torque map as utilized in the present invention to obtain an engine torque;

FIG. 4 is a diagram of a torque transmission ratio map as utilized in the present invention to obtain a torque transmission ratio of a torque converter;

FIG. 5 is a diagram of a rotational difference map as utilized in the present invention to obtain a difference in rotational speed for an input shaft; and

FIG. 6 is a flowchart of a method of the present invention.

### DESCRIPTION OF THE PREFERRED EMBODIMENT

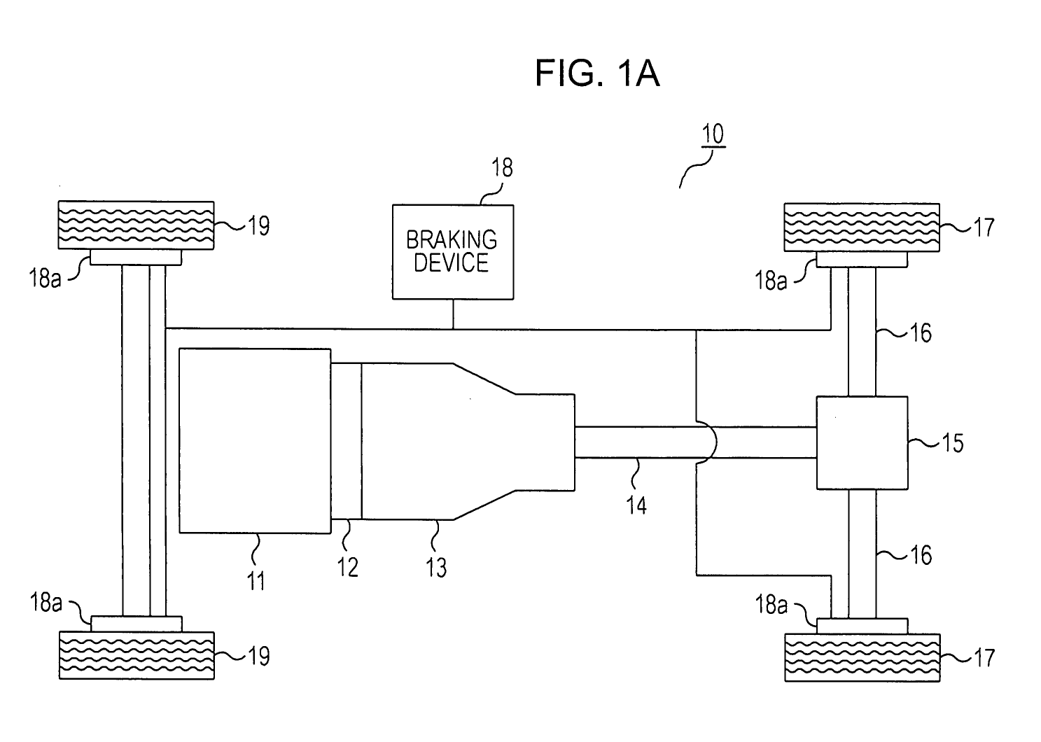

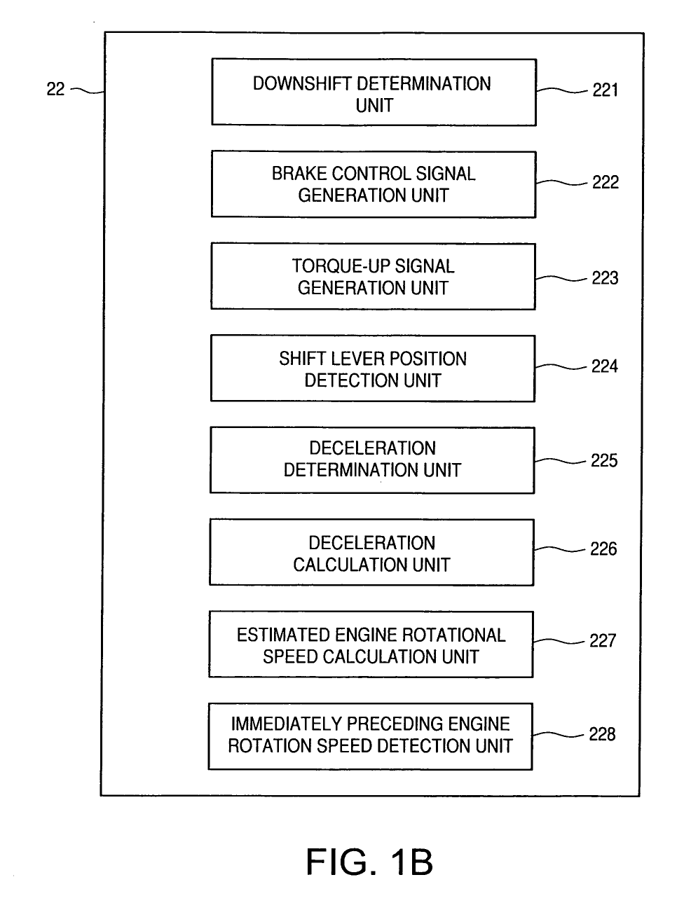

With reference to FIGS. 1 to 6, an embodiment of the driving assist apparatus of the present invention will be described. FIG. 1 shows an engine 11 connected to an automatic transmission 13 via a torque converter 12. Specifically, a crankshaft of the engine 11 is connected to an input shaft of the automatic transmission 13 via the torque converter 12 (a pump impeller and a turbine runner). An output shaft of the automatic transmission 13 is connected to a final reduction device 15 via a propeller shaft 14.

The final reduction device 15, which includes reduction gears and a differential unit, reduces the drive force transmitted from the propeller shaft 14 and increases the torque to distribute the drive force to two drive shafts 16 each extending in a direction perpendicular to the propeller shaft 14. The two drive shafts 16 rotate respective drive wheels 17 with the drive force distributed by the final reduction device 15.

A braking device 18 functioning as a brake driving unit includes brake drums 18a associated with each of the drive wheels 17 and driven wheels 19 of the vehicle 10. The braking device 18 brakes the vehicle 10 by supplying and draining hydraulic pressure to and from wheel cylinders provided for the brake drums 18a.

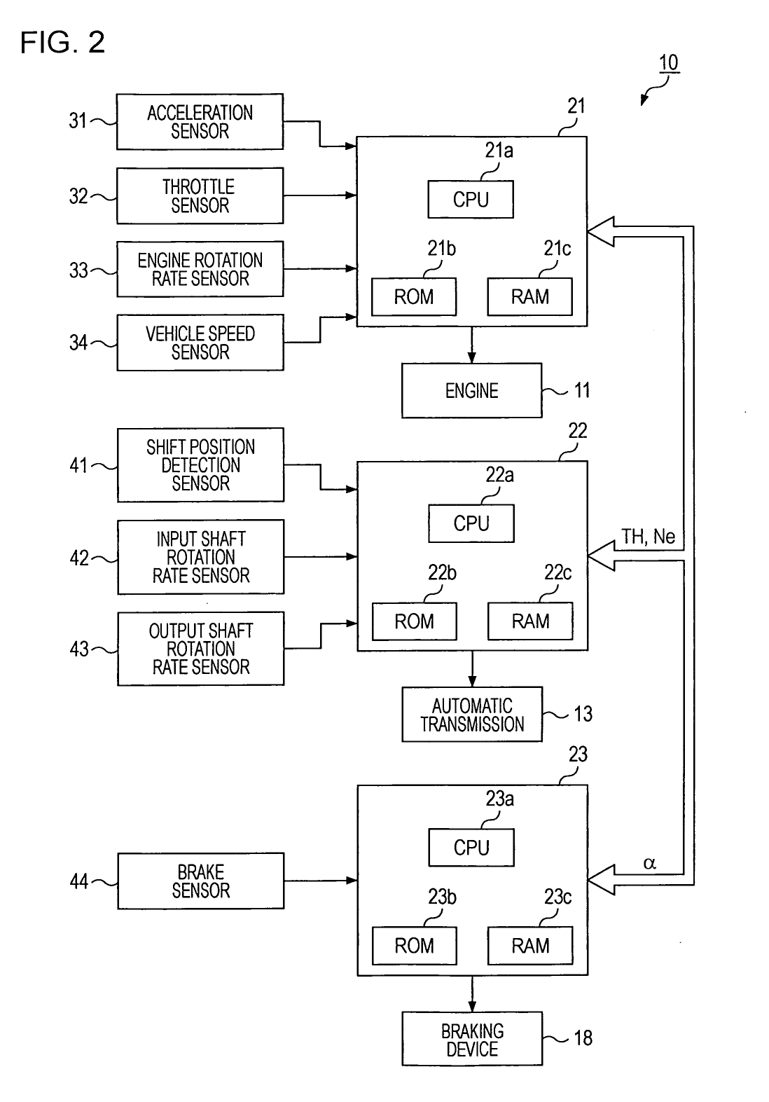

FIG. 2 is a block diagram showing an electrical configuration of the driving assist apparatus of the invention. As illustrated in FIG. 2, the vehicle 10 includes an electronic engine control unit 21 for control of the engine 11, an electronic transmission control unit 22 for control of the automatic transmission 13, and an electronic brake control unit 23 for control of the braking device 18. The electronic engine control unit 21, the electronic transmission control unit 22, and the electronic brake control unit 23 are configured to exchange data with one another.

Further, the embodiment shown in FIG. 1 includes an acceleration sensor 31 for detecting the amount of depression of an accelerator pedal, a throttle sensor 32 for detecting degree of throttle opening TH of a throttle valve, an engine rotational speed sensor 33 for detecting a rotational speed Ne of the engine 11, and a vehicle speed sensor 34 for detecting the vehicle speed. This embodiment further includes a shift position detection sensor 41 for detecting the position of a shift lever, an input shaft rotational speed sensor 42 for detecting the rotational speed Nin of the input shaft of the automatic transmission 13, an output shaft rotational speed sensor 43 for detecting rotational speed Nout of the output shaft of the automatic transmission 13, and a brake sensor 44 for detecting the degree of depression of a brake pedal.

The electronic engine control unit 21 is a computer including a CPU (Central Processing Unit) 21a , storage devices such as a ROM (Read-Only Memory) 21b and a RAM (Random Access Memory) 21c , and an input-output interface. The electronic engine control unit 21 (the CPU 21a ) receives input of a variety of detection signals from the acceleration sensor 31, the throttle sensor 32, the engine rotational speed sensor 33, the vehicle speed sensor 34, and so forth.

In accordance with a control program stored in the ROM 21b , and on the basis of the detection signals from the respective sensors 31 to 34, the CPU 21a calculates the degree of depression of the accelerator pedal, the degree of throttle opening TH, the engine speed Ne, and the vehicle speed at a given time, and stores the calculated data in the RAM 21c . Then, on the basis of the respective sets of calculated data obtained by calculation based on the respective detection signals, the CPU 21a executes the control program stored in the ROM 21b , to thereby control the amount of fuel injection, to control ignition timing, to control the throttle, and to provide a variety of other engine controls.

Further, the electronic engine control unit 21 (the CPU 21a ) is configured to output to the electronic transmission control unit 22 and the electronic brake control unit 23 the respective sets of calculated data at a given time.

Further, upon input of a manual downshift signal from the electronic transmission control unit 22, the electronic engine control unit 21 (the CPU 21a ) shifts to a control mode according to the manual downshift transmission mode signal, and executes control to increase the engine rotational speed Ne. That is, the electronic engine control unit 21 (the CPU 21a ) controls the engine 11 to increase the engine rotational speed Ne to mitigate gearshift shock associated with an increase in gear ratio M of the automatic transmission 13 due to a downshift operation.

As illustrated in FIG. 1B, the electronic transmission control unit 22 functions as a downshift determination unit 221, a brake control signal generation unit 222, a torque-up signal generation unit 223, a shift lever position detection unit 224, a deceleration determination unit 225, a deceleration calculation unit 226, an estimated engine rotational speed calculation unit 227, and an immediately preceding engine rotational speed detection unit 228. The electronic transmission control unit 22 is a computer including a CPU 22a , storage devices such as a ROM 22b and a RAM 22c , and an input-output interface. The electronic transmission control unit 22 (the CPU 22a ) receives input of a variety of detection signals from the shift position detection sensor 41, the input shaft rotational speed sensor 42, the output shaft rotational speed sensor 43, and so forth.

In accordance with a control program stored in the ROM 22b , and on the basis of the detection signals from the respective sensors 41 to 43, the CPU 22a calculates the shift position of the shift lever, the transmission input shaft rotational speed Nin, and the transmission output shaft rotational speed Nout at a given time, and stores the calculated data in the RAM 22c.

Further, the CPU 22a is configured to cause the respective calculated data sets, obtained from the calculation by the electronic engine control unit 21 (the CPU 21a ), to be input at the given time from the electronic engine control unit 21 and stored in the RAM 22c.

On the basis of the calculated data stored in the RAM 22c , the CPU 22a processes signals in accordance with the control program stored in the ROM 22b to provide drive control of a frictional engagement device (not illustrated) in the automatic transmission 13, and to execute a variety of controls to change the gear ratio M of the automatic transmission 13. For example, the CPU 22a sets the gear ratio M in accordance with a gearshift map (not illustrated) stored in the ROM 22b . The gearshift map has gear ratios M correlated with amounts of accelerator pedal depression and vehicle speeds. Then, the CPU 22a executes drive control of the frictional connection device to change the gear ratio M of the automatic transmission 13 to the gear ratio M read from the gearshift map.

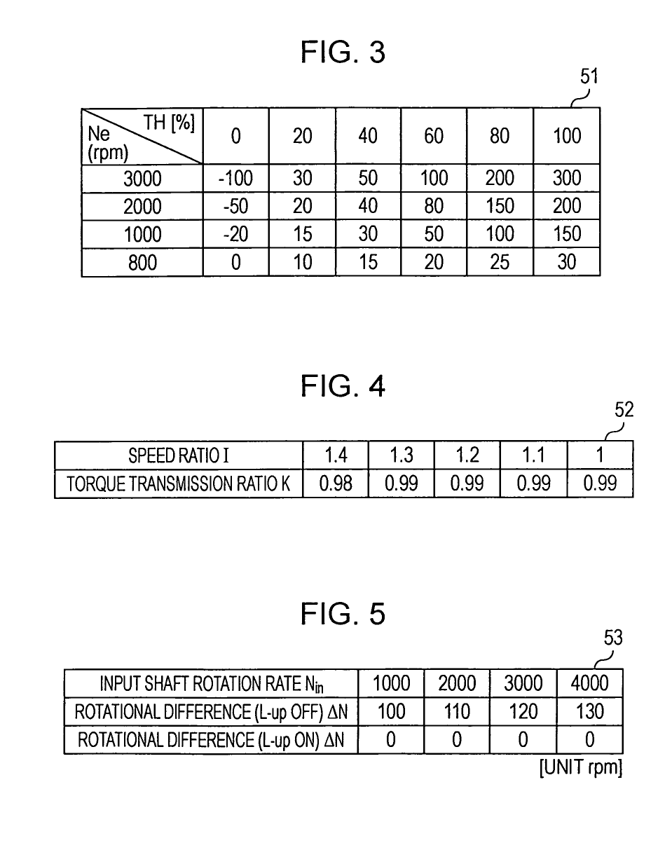

The ROM 22b stores a torque map 51 for obtaining an engine torque Te of the engine 11. As illustrated in FIG. 3, the torque map 51 correlates engine torques Te with different degrees of throttle opening TH and different engine rotational speeds Ne. The data of the torque map 51 has been previously obtained from tests or experiments (predetermined) and stored.

Further, the ROM 22b stores a torque transmission ratio map 52 for obtaining torque transmission ratio K of the torque converter 12. As illustrated in FIG. 4, the torque transmission ratio map 52 has data for the torque transmission ratios K correlated with speed ratios I (i.e., the ratios obtained by dividing the input shaft rotational speed Nin of the automatic transmission 13 by the engine rotational speed Ne). The data has been previously obtained from tests or experiments (predetermined) and stored.

Further, the ROM 22b stores a rotational difference map 53 for obtaining the difference in rotational speed between the engine rotational speed Ne and the input shaft rotational speed Nin of the automatic transmission 13. Because the torque converter 12 is located between the engine 11 and the automatic transmission 13, the engine rotational speed Ne and the input shaft rotational speed Nin of the automatic transmission 13 will not be the same unless in the lockup clutch of the torque converter 12 is “ON” (engaged).

As illustrated in FIG. 5, the rotational difference map 53 stores the data for differences AN in the engine rotational speeds Ne correlated with different input shaft rotational speeds Nin. As with the other data, the data has been previously obtained from tests or experiments (predetermined) and stored. By addition of the valve for the rotational speed difference AN to the input shaft rotational speed Nin, the engine rotational speed Ne at any given time (an estimated engine rotational speed) can be determined.

If the electronic transmission control unit 22 (the CPU 22a ) determines, on the basis of the detection signal from the shift position detection sensor 41, that the shift lever has been moved for a downshift, the electronic transmission control unit 22 shifts from a normal automatic transmission mode to a manual downshift transmission mode. Upon the shift to the manual downshift transmission mode, the CPU 22a generates a drive signal for increasing the gear ratio M of the automatic transmission 13 in accordance with the gearshift map, and outputs the signal to the frictional engagement (connection) device. In this process, upon a shift to the manual downshift transmission mode, the CPU 22a generates a manual downshift transmission mode signal indicative of the ON state of the manual downshift transmission mode, and outputs the signal to the electronic engine control unit 21 and the electronic brake control unit 23.

In increasing the gear ratio M of the automatic transmission 13, the CPU 22a generates a control signal for rapidly increasing the engine torque to enable a smooth gearshift without causing a sudden and large gearshift shock, and outputs that signal to the electronic engine control unit 21. Then, in the manual downshift transmission mode, if the frictional engagement device makes a connection in response to the drive signal, and if the gear ratio M of the automatic transmission 13 is then increased, the CPU 22a signals a shift from the manual downshift transmission mode to the normal automatic transmission mode. Upon the shift from the manual downshift transmission mode to the automatic transmission mode, the CPU 22a generates an automatic transmission mode signal indicating that the automatic transmission mode is now ON, and outputs that signal to the electronic engine control unit 21 and to the electronic brake control unit 23.

In the manual downshift transmission mode, the CPU 22a executes a driving assist control program stored in the ROM 22b to mitigate gearshift shock and to thereby improve the sensation of the gearshift felt by the driver. The driving assist control program refers to a routine for causing the vehicle 10 to smoothly move without generating a sensation of acceleration in the gearshift to the requested gear ratio M, based on the requested new gear ratio M, the gear ratio M prior to the downshift, and the vehicle speed.

More specifically, in a downshift to the requested gear ratio M, the gear ratio M is increased, and the electronic engine control unit 21 controls the engine 11 to increase the engine rotational speed Ne. As the engine rotational speed Ne is increased, the engine torque output is increased. If there arises a difference between the timing of the increase in the engine torque output and the timing of the connection through engagement of the frictional engagement device, the engine torque output is transmitted to the output shaft of the automatic transmission 13, and the vehicle 10 is accelerated. The purpose of the driving assist control is to estimate and eliminate that acceleration.

In the driving assist control process, whether or not the vehicle 10 will be accelerated is determined. Then, if it is determined that the vehicle 10 will be accelerated, a deceleration α for preventing that acceleration is calculated and output to the electronic brake control unit 23. Then, a braking force based on the calculated deceleration α is applied to the vehicle 10 via the electronic brake control unit 23 to diminish the acceleration which would otherwise occur.

The electronic brake control unit 23 is a computer including a CPU 23a , storage devices such as a ROM 23b and a RAM 23c , and an input-output interface. The electronic brake control unit 23 receives input of a detection signal from the brake sensor 44 and, responsive thereto, the CPU 23a calculates the extent of depression of the brake pedal at a given time in accordance with a control program stored in the ROM 23b , and stores the calculated data in the RAM 23c.

Further, under control of the CPU 23a respective data sets calculated at a given time by the electronic engine control unit 21 (the CPU 21a ) are input from the electronic engine control unit 21 and updated and stored in the RAM 23c . Further, under control of the CPU 23a respective data sets calculated at a given time by the electronic transmission control unit 22 (the CPU 22a ) are input from the electronic transmission control unit 22 and updated and stored in the RAM 23c.

On the basis of the calculated data stored in the RAM 23c , the CPU 23a executes the control program stored in the ROM 23b to process signals for drive control of the braking device 18 which, in turn, controls braking of the vehicle 10.

Further, upon input of the manual downshift transmission mode signal from the electronic transmission control unit 22 and a data signal representing the deceleration α, the electronic brake control unit 23 shifts to a control mode according to the manual downshift transmission mode signal, and controls braking based on the deceleration α.

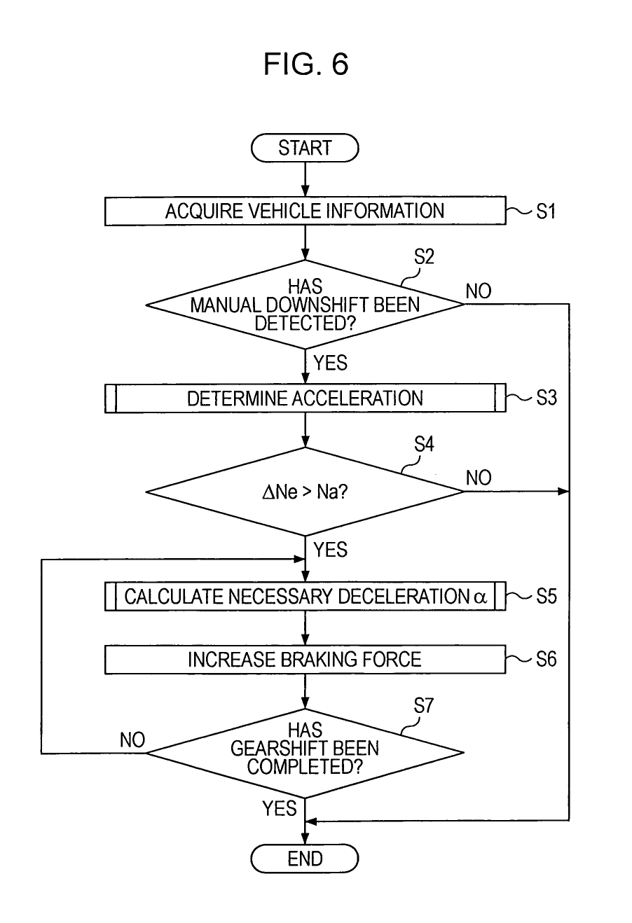

An embodiment of the process for driving assist control of the present invention, executed by the embodiment of the driving assist apparatus described above, will now be described with reference to the flowchart of FIG. 6. Here, it is assumed that the vehicle 10 is traveling on a road under control of the driver and, the respective sensors 31 to 34 and 41 to 44 output the respective detection signals to the corresponding electronic control devices 21, 22, and 23 at a given time.

On the basis of the detection signals from the shift position detection sensor 41, the input shaft rotational speed sensor 42, and the output shaft rotational speed sensor 43, the electronic transmission control unit 22 (the CPU 22a ) calculates vehicle information such as the position of the shift lever, the transmission input shaft rotational speed Nin, and the transmission output shaft rotational speed Nout at the given time, and stores the calculated vehicle information in the RAM 22c (Step S1). Further, the CPU 22a acquires from the electronic engine control unit 21 vehicle information such as the degree of depression of the accelerator pedal, the throttle opening degree TH, the engine rotational speed Ne, and the vehicle speed at the given time as calculated by the electronic engine control unit 21, and stores the acquired vehicle information in the RAM 22c . Further, the CPU 22a acquires from the electronic brake control unit 23 vehicle information including the degree of brake pedal depression at the given (predetermined) time calculated by the electronic brake control unit 23, and stores the acquired vehicle information in the RAM 22c.

Subsequently, on the basis of the detection signal from the shift position detection sensor 41, the CPU 22a determines whether or not the shift lever has been moved for a downshift (“downshift operation”) (Step S2). If the CPU 22a determines that a downshift operation has been performed (YES in Step S2), the CPU 22a shifts from the automatic transmission mode to the manual downshift transmission mode, and proceeds to Step S3.

Meanwhile, if the CPU 22a determines that there has been no downshift operation (NO in Step S2), the CPU 22a ends the procedure while maintaining the automatic transmission mode, i.e. without shifting to the manual downshift transmission mode, and returns to wait for a downshift operation.

At Step S3, the CPU 22a outputs the manual downshift transmission mode signal to the electronic engine control unit 21 and the electronic brake control unit 23. Thereafter, the CPU 22a determines whether or not the vehicle 10 would accelerate before the completion of the gearshift, i.e., whether or not to provide deceleration by operation of the braking device 18 (Step S3).

In response to the manual downshift transmission mode signal, the electronic engine control unit 21 increases the engine rotational speed Ne to mitigate the deceleration shock.

Meanwhile, the CPU 22a reads from the RAM 22c the engine rotational speed Ne, obtained immediately before the gearshift. Further, the CPU 22a obtains the engine rotational speed Ne immediately after the gearshift (hereinafter, “estimated engine rotational speed Ne₂”).

To obtain the estimated engine rotational speed Ne₂ obtainable immediately after the gearshift, the transmission input shaft rotational speed Nin obtainable immediately after the gearshift (hereinafter, “the estimated input shaft rotational speed Nin₂) is first calculated. The estimated input shaft rotational speed Nin₂ is calculated using the following equation (1):

Nin₂=(Nin₁×Ma)/Mb (1)

Wherein, Nin₁ represents the current input shaft rotational speed Nin obtained immediately before the gearshift, Ma represents the gear ratio M obtainable immediately after the gearshift, and Mb represents the gear ratio M obtained immediately before the gearshift.

To make the foregoing calculation, the CPU 22a first reads from the RAM 22c the current input shaft rotational speed Nin₁ obtained immediately before the gearshift. Further, the CPU 22a obtains the gear ratio Ma immediately after the gearshift and the gear ratio Mb immediately before the gearshift on the basis of the gear ratio Ma after the gearshift and the gear ratio Mb before the gearshift temporarily stored in the RAM 22c.

After the estimated input shaft rotational speed Nin₂ has been calculated, the CPU 22a obtains the estimated engine rotational speed Ne₂ for the estimated input shaft rotational speed Nin₂ utilizing the rotational difference map 53 illustrated in FIG. 5. To make this determination, after the engine rotational speed Ne₁ immediately before the gearshift and the estimated engine rotational speed Ne₂ immediately after the gearshift have been obtained, the CPU 22a calculates the difference ΔNe, i.e., Ne₂—Ne₁. Subsequently, the CPU 22a compares the calculated difference ΔNe (Ne₂—Ne₁) with a reference value Na (Step S4). The reference value Na represents the maximum allowable difference ΔNe which will allow a smooth downshift to the requested gear ratio Ma without producing a sensation of acceleration. In the present embodiment, the reference value Na is a predetermined value, obtained by test or experiment, and prestored in the ROM 22b.

If the CPU 22a determines that the difference ΔNe is greater than the reference value Na (YES at Step S4), the CPU 22a first calculates a necessary deceleration α on the assumption that the gearshift will be performed during the acceleration of the vehicle 10 (Step S5). That is, the CPU 22a calculates the deceleration α of the vehicle 10 for enabling a smooth gearshift without producing a sensation of acceleration.

The deceleration α of the vehicle 10 is calculated from the following equation (2), wherein Tt represents acceleration and deceleration torque generated on an axle by the automatic transmission 13:

α=(Tt/R)/W (2)

In equation (2), R and W represent the tire radius and the weight of the vehicle 10, respectively.

The tire radius R and the weight W of the vehicle 10 are predetermined values. Thus, after the acceleration and deceleration torque Tt is obtained, the deceleration α of the vehicle 10 can be obtained from equation (2). The acceleration and deceleration torque Tt is calculated from the following equation (3):

Tt=Te×K×M×J (3)

In equation (3), Te, K, M, and J represent the engine torque, the torque transmission ratio of the torque converter 12, the gear ratio of the automatic transmission 13, and the differential ratio (the reduction ratio) of the final reduction device 15, respectively. The gear ratio M and the differential ratio J are predetermined values. Thus, after the engine torque Te and the torque transmission ratio K of the torque converter 12 are obtained, the acceleration and deceleration torque Tt on the axle can be obtained from equation (3).

The engine torque Te can be obtained with reference to the torque map 51 of FIG. 3 stored in the ROM 22b . The CPU 22a reads the estimated engine rotational speed Ne₂ obtained at Step S3 from the RAM 22c . Then, the CPU 22a reads the throttle opening degree TH obtained at Step S1 from the RAM 22c.

Then, by reference to the torque map 51 stored in the ROM 22b , the CPU 22a obtains the estimated engine torque Te for the estimated input shaft rotational speed Nin₂ and the degree of throttle opening TH. The torque transmission ratio K of the torque converter 12 is obtained by reference to the torque transmission ratio map 52 of FIG. 4 stored in the ROM 22b.

The CPU 22a first reads from the RAM 22c the estimated engine rotational speed Ne₂ and the estimated input shaft rotational speed Nin₂ obtained at Step S3, and then calculates the speed ratio I by the following equation (4):

Speed ratio I=Estimated input shaft rotational speed Nin₂/Estimated engine rotational speed Ne₂ (4)

After the speed ratio I has been calculated, the CPU 22a obtains the torque transmission ratio K of the torque converter 12 for the speed ratio I by reference to the torque transmission ratio map 52 stored in the ROM 22b.

Then, after the estimated engine torque Te and the torque transmission ratio K have been obtained, the CPU 22a calculates the acceleration and deceleration torque Tt (i.e., Te×K×M×J) transferred to the axle by the automatic transmission 13. After the acceleration and deceleration torque Tt has been calculated, the CPU 22a calculates the deceleration α (i.e., (Tt/R)/W) of the vehicle 10.

If the difference ΔNe is equal to or less than the reference value Na (NO at Step S4), the routine is ended without the calculation of the deceleration valve α. After the deceleration α of the vehicle 10 (i.e., (Tt/R)/W) has been calculated, the CPU 22a calculates the braking force on the basis of the deceleration α, and applies the braking force to the vehicle 10 via the electronic brake control unit 23 until the completion of the gearshift (Step S6). Accordingly, the gearshift to the requested gear ratio Ma is smoothly completed without any sensation of acceleration.

Then, upon completion of the gearshift (YES at Step S7), the CPU 22a ends the driving assist control routine and waits for another downshift operation of the shift lever.

Effects and advantages of the above-described embodiment are summarized below.

(1) In the foregoing embodiment, in the course of the downshift, the torque of the engine 11 is increased and the electronic transmission control unit 22 determines whether or not the vehicle 10 would otherwise be accelerated before the completion of the gearshift. If the electronic transmission control unit 22 determines that the vehicle 10 would be accelerated, the electronic transmission control unit 22 calculates the deceleration valve α for offsetting the potential acceleration, and controls the braking device 18 via the electronic brake control unit 23 in accordance with the calculated deceleration α, to thereby apply a proper braking force to the vehicle 10.

Accordingly, it is possible to suppress the acceleration of the vehicle 10 which would otherwise be produced by the increase in the engine torque due to the downshift operation.

(2) Because the braking device 18 is controlled to offset the acceleration of the vehicle 10 by braking, it is possible to more reliably, easily and accurately suppress the acceleration, as compared to an apparatus and method in which the timing of the connection made by frictional engagement device of the automatic transmission 13 is controlled to suppress the acceleration and that in which the timing of the increase of the engine torque is controlled.

The above-described embodiment may be modified as follows. While in the above-described embodiment, responsive to the downshift operation of the shift lever, the engine rotational speed is increased to thereby increase the engine torque, the present invention is equally applicable to a system which does not increase the torque in a downshift.

In the above-described embodiment, responsive to downshift operation of the shift lever, the automatic transmission mode shifts to the manual downshift transmission mode and a determination is made as to whether or not the vehicle 10 would otherwise be accelerated (Step S2). Alternatively, the embodiment may be modified such that the automatic transmission mode shifts to the manual downshift transmission mode and a determination is made as to whether or not the vehicle 10 would otherwise be accelerated if there has been a downshift operation of the shift lever, and if the accelerator pedal has not been depressed. In this case also, brake control is consistent with the intention of the driver.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A driving assist method for a vehicle including an automatic transmission for performing a gearshift to change a gear ratio of the transmission on the basis of a gearshift map and to increase the gear ratio of the transmission in response to a downshift-operation of a shift lever, the method comprising:
calculating, responsive to the downshift operation of the shift lever, a post-gearshift engine rotational speed;
comparing the post-gearshift engine rotational speed with a pre-gearshift engine rotational speed, and determining whether or not to decelerate with a brake control unit, on the basis of the result of the comparison;
calculating a necessary deceleration based on a determination of the performance in deceleration by the brake control unit; and
controlling braking of the vehicle, utilizing the brake control unit, on the basis of the calculated necessary deceleration, until completion of the gearshift.

2. The driving assist method according to claim 1, further comprising:
increasing torque of the engine responsive to the downshift operation of the shift lever.

3. A computer-readable medium encoded with a driving assist control program for causing a computer to control changing a gear ratio of a transmission of a vehicle, in accordance with a gearshift map, and to control the transmission to perform a gearshift to increase the gear ratio of the transmission in response to a downshift operation of a shift lever, the program causing the computer to function as:
a downshift determination unit for determining the downshift operation of the shift lever;
an estimated engine rotational speed calculation unit for calculating, on the basis of the downshift operation of the shift lever, a post-gearshift engine rotational speed;
an immediately preceding engine rotational speed detection unit for detecting a pre-gearshift engine rotational speed obtained before the gearshift;
a deceleration determination unit for comparing the post-gearshift engine rotational speed with the pre-gearshift engine rotational speed, and determining whether or not a brake control unit is to decelerate the vehicle on the basis of the result of the comparison;
a deceleration calculation unit for calculating a necessary deceleration in accordance with a determination by the deceleration determination unit of performance of the brake control unit in deceleration; and
a brake control signal generation unit for generating, on the basis of the necessary deceleration calculated by the deceleration calculation unit, a control signal for controlling braking of the vehicle, and for outputting the generated signal to the brake control unit until completion of the gearshift.

4. The driving assist control program according to claim 3,
wherein the program further causes the computer to function as a torque-up signal generation unit for generating a control signal for increasing torque of the engine responsive to the downshift operation of the shift lever.

5. A driving assist apparatus for a vehicle including an automatic transmission for performing a gearshift to change a gear ratio of the transmission on the basis of a gearshift map and to increase the gear ratio of the transmission responsive to a downshift operation of a shift lever, the apparatus comprising:
a shift lever operation position detection unit for detecting a position of the shift lever;
a downshift determination unit for determining the downshift operation of the shift lever on the basis of a detection signal from the shift lever position detection unit;
an estimated engine rotational speed calculation unit for calculating, upon determination by the downshift determination unit of the downshift operation, a post-gearshift engine rotational speed, as an estimated engine rotational speed, on the basis of the downshift operation;
an immediately preceding engine rotational speed detection unit for detecting a pre-gearshift engine rotational speed obtained before the gearshift as an immediately preceding engine rotational speed;
a deceleration determination unit for comparing the estimated engine rotational speed with the immediately preceding engine rotational speed, and determining whether or not to decelerate with a brake control unit, on the basis of the result of the comparison;
a deceleration calculation unit for calculating a necessary deceleration based on a determination, by the deceleration determination unit of the performance in deceleration by the brake control unit; and
a brake control signal generation unit for generating, on the basis of the necessary deceleration calculated by the deceleration calculation unit, a control signal for control of braking of the vehicle, and outputting the signal to the brake control unit until completion of the gearshift.

6. The driving assist apparatus according to claim 5, further comprising:
an opening degree determination unit for determining whether or not a throttle is closed,
wherein, responsive to a determination that the throttle is closed, the deceleration determination unit determines whether or not the brake driving unit is to decelerate the vehicle.

7. The driving assist apparatus according to claim 5, further comprising:
a torque-up signal generation unit for generating, responsive determination of the downshift operation, a control signal for increasing torque of the engine.
